(19) United States
(12) Patent Application Publication
(10) Pub. No.: US 2010/0222920 A1
(43) Pub. Date: Sep. 2, 2010

(54) SYSTEM AND A METHOD FOR REMOTELY MONITORING THE OPERATIONAL LIFE OF CONVEYORS OF ARTICLES

(76) Inventor: Andrea Andreoli, Modena (IT)

Correspondence Address: QUARLES & BRADY LLP, 411 E. WISCONSIN AVENUE, SUITE 2040, MILWAUKEE, WI, 53202-4497, US

(21) Appl. No.: 12/681,929

(22) PCT Filed: Oct. 9, 2008
(86) PCT No.: PCT/EP08/63510

§ 371 Date: Apr. 7, 2010

(30) Foreign Application Priority Data
Oct. 12, 2007 (IT) MI2007A001980
Mar. 28, 2008 (IT) MI2008A000528

(51) Int. Cl. B65G 43/00

(52) U.S. Cl. 700/230

(57) ABSTRACT

The invention relates to a monitoring system for a conveyor (130) of articles comprising a plurality of conveyor components, said conveyor components being conceived to undergo a plurality of revolutions in use, the monitoring system comprising at least one sensor device (SM), associated with a corresponding conveyor component, adapted to enable determination of operating data associated with revolutions of the conveyor component; a data collection and processing system (140; 150; 180; 190) operationally coupled to the at least one sensor device, arranged to determine the operating data and efficiency data of the conveyor component based on the operating data. The invention further relates to a method of monitoring a conveyor of articles.

### FIELD OF THE INVENTION

The invention relates to a monitoring system for a conveyor of articles comprising a plurality of conveyor components, said conveyor of articles being conceived to undergo a plurality of revolutions in use. The invention further relates to a method of monitoring a conveyor of articles comprising a plurality of conveyor components.

### BACKGROUND OF THE INVENTION

Conveyors of articles, and particularly belt, mat or chain conveyors, are used in various industrial or civil environments, from food industry to airports.

In very general terms, a conveyor includes one or more conveyor components, like transport elements (belt, mat, chain), adapted to provide a support surface for the articles to be transported, and that are caused to advance along a transport path, by suitable driving means like electric motors, pinions, driving cogwheels, belts.

Particularly, mat or chain conveyors use, as a transport mean, a chain made of different segments that are formed by a plurality of links, joined (for instance, hinged) to one another, e.g. by means of pins, to form a substantially plane, smooth support surface, intended for supporting the articles to be transported.

Typically, the constitutive components of the conveyors of articles (for instance, the links of the chain or mat, the components necessary to their joining, like the pins, the pinions, the chain driving cogwheels and so on), are manufactured by one or more firms specialized in the components production; the conveyor assembled by means of such components is then sold to the end user (for instance, a food products packaging company) and installed at the premises thereof.

Like any mechanical system, also the conveyors and their constitutive components are subject to wear during their operation. Particularly, the links that form the chain segments can be damaged if they are submitted to prolonged stress. For instance, as a consequence of the loads that the chain sustains during its use, the links that form it can tend to become spaced apart, with the result that the surface of the transport element does not guarantee any longer the required support. Additionally, in use, dirt inevitably accumulates on the transport chain, which alters the functionality of the support surface.

The effect of such wear, damages, dirt can cause failures or significant malfunctioning of the conveyor, which may prevent the correct operation thereof or at least significantly reduce its efficiency.

For example, a transport chain with links excessively spaced apart from each other, or with excessive dirt accumulated on the support surface of the articles, can cause more frequent stops of the flow of the transported articles, and consequent falls of the articles from the transport chain. When this occurs, the conveyor needs to be stopped, in order to put again the fallen articles onto the belt, and then restarted. The dead times inherent to these operations can determine a significant reduction in the efficiency, even down to 50%.

For this reason, the conveyors would in principle need continuous inspections by qualified personnel to check the state of the conveyor and of the constitutive components thereof, at least for those which are more critical and more subject to wear, like for instance the links of the transport chains or belts, in order to assess their wear conditions.

However, this does not actually happen.

As a matter of fact, the end user generally continues to make the conveyor work until the break of one of its components, for instance the chain, determines the definitive stop of the conveyor, and only at that moment the component is repaired, for example by replacing the broken chain segment with a new one.

In this way, the conveyor is made to work for more or less long periods of time while being in non-optimal conditions, that significantly reduce the efficiency.

On the other side, it is not simple to convince the end users to modify their habits, in order to convince them to carry out periodic, frequent controls of the plants, since the productivity losses caused by the stop of the conveyors to perform their check would not be well accepted.

An embodiment of a monitoring system of a conveyor of articles is known from WO 03/09373. In the known monitoring system a conveyor comprising a plurality of conveyor component, notable conveyor chains, is provided with a laser sensor for monitoring stretch in the chain which occurs during revolution of the conveyor in use. The known system is arranged to automatically acquire data related to stretch, for example, for determining an actual distance between chain elements in use. When the known monitoring system determines that an excessive stretch in a chain element occurs, the conveyor is stopped for maintenance and replacement of a worn out component.

### SUMMARY OF THE INVENTION

It is a disadvantage of the known system that maintenance or repair measures are applied only after it is detected that a chain component exhibits excessive wear. In this way, it is possible that the conveyor is operated under conditions of a substantial wear, yet not excessive, which may lead to accepting the conveyor to operate with a substantially decreased efficiency.

It is an object of the invention to provide a monitoring system which enables maintaining a pre-determined efficiency level of a conveyor of articles. It is a further object of the invention to improve procedures of control of the conditions and of maintenance of the conveyors, substantially eliminating or at least limiting the drawback of the prior art.

To this end the monitoring system according to the invention comprises:
at least one sensor device (SM), associated with a corresponding conveyor component, adapted to enable determination of operating data associated with revolutions of the conveyor components;
a data collection and processing system (140; 150; 180; 190) operationally coupled to the at least one sensor device, arranged to determine the operating data and efficiency data of the conveyor component based on the operating data.

The invention is based on the insight that by automatically determining efficiency data of the conveyor based on the operating data, a desired pre-determined efficiency level of the conveyor may be guaranteed. As a result, suitable interventions, like, maintenance and/or replacement of the conveyor components may take place before the efficiency decreases substantially, for example due to wear.

In an embodiment of a monitoring system according to the invention, the data collection and processing system is arranged to determine a trend in the efficiency data of the conveyor.

It is found to be preferable, to allow the monitoring system to determine and/or to track a trend on the efficiency data of the conveyor. For example, such data may be used as reference data for further conveyors of the same type, for tracking their operating conditions. Additionally or alternatively, the trend of the efficiency data may be used for extrapolating thereof for anticipating a moment when the efficiency of the conveyor is expected to decrease below an allowable level.

In a further embodiment of a monitoring system according to the invention, the data collection and processing system is arranged to statistically analyze the operating data for determining said trend.

Preferably, the operating data is subjected to a profound analysis, like regression analysis, or other suitable statistical analysis for determining a trend in the efficiency data. This feature is advantageous as it may suitable remove noise in the input data used for such analysis.

In a still further embodiment of a monitoring system according to the invention, the data collection and processing system is further arranged to forecast an operating life of the conveyor components based on said trend.

The operating life is considered to be an important parameter for a user, as well as for a manufacturer of conveyor elements. When the life time is being forecast, based on analysis of the efficiency data of the conveyor, the user and the manufacturer will know beforehand when maintenance and/or repair measures have to be undertaken. For the user such planning is advantageous as a due continuity of his business can be enabled. For the manufacturer such planning is advantageous as he may be enabled to efficiently manage his logistics, for example his stocks of spare parts.

In a still further embodiment of a monitoring system according to the invention, the data collection and processing system is further arranged to signal a time for an intervention of the conveyor of articles when a level of efficiency is below a predetermined level.

This feature is advantageous, as the conveyor may be used fully until the efficiency is deteriorated. This measure ensures cost-effectiveness of maintenance, as, rather than relying on forecast, conveyors, still exhibiting adequate efficiency levels, may still be kept in use.

In a still further embodiment of a monitoring system according to the invention, the operating data is determined for different use conditions.

Preferably, in the monitoring system according to the invention, different operating conditions are taken into account. For example, the monitoring system may be arranged to provide separate efficiency trends for a conveyor for different load conditions, different propagating speeds, different durations of uninterrupted up-times, and so on. Due to this feature, an overall accuracy of determination of efficiency trends and corresponding life times may be increased.

In a still further embodiment of a monitoring system according to the invention, the operating data comprises a parameter selectable from a group consisting of: a number of revolutions of conveyor components, advancement speed of the conveyor components, number of stops of the conveyor, idle state and activity state of the conveyor and/or load data of the conveyor.

It will be appreciated that operating data related to a number of revolutions of the conveyor components, i.e. a number of cycli, may be directly determined using the sensor device. In order to determine operational data of other type, as is set forth in the preceding, it is possible to address supplementary data or measurements, as is explained with reference to FIG. 2 and FIG. 3.

Further advantageous embodiments of the monitoring system according to the invention are set forth in the appended claims 8-32.

The method according to the invention comprises the steps of:
automatically determining operating data associated with revolutions of the conveyor components;
determining efficiency data of the conveyor component based on the operating data.

Preferably, a method according to the invention, further comprises a step of determining a trend in the efficiency of the conveyor. More preferably, for determining said trend the operating data is statistically analyzed. In a further embodiment of the method according to the invention, the method further comprises the step of forecasting an operating life of the conveyor components based on said trend. Further advantageous embodiment of the method of the invention comprises an additional step of signalling a time for an intervention of the conveyor of articles when a level of efficiency is below a predetermined level. Advantageously, in the method according to the invention the operating data is acquired for different use conditions, wherein the operating data comprises a parameter, which may be selectable from a group consisting of: a number of revolutions, advancement speed of the conveyor, number of stops of the conveyor, idle state and activity state of the conveyor and/or load data of the conveyor.

According to another aspect of the invention, a method of providing service or guarantee contracts for a user is provided. Accordingly, the conveyors manufacturer can in particular offer to the end user specific service/guarantee contracts that contemplate scheduled maintenance interventions for the replacement of those conveyor components which, based on the obtained statistics related to efficiency data, no longer ensure that the conveyor operates at a predetermined level of efficiency, before coming to the definitive breakage of such components. The interventions can for example be scheduled based on the working hours of the components, keeping track of the conditions of use thereof (more critical conditions of use will generally require more frequent replacement interventions).

In particular, such contracts may be based on a pre-determined level of conveyor efficiency, guaranteed for a pre-determined lifetime. Such contract may be further specified regarding operational conditions, of the conveyor, like load, propagating speed and so on, conditioned to the fact that the level of efficiency of the plant as a whole does not fall below a predetermined level.

The sale of the component of the conveyor can thus be replaced by the sale of working hours with predetermined levels of efficiency in determined conditions of use: the end user will thus pay to the components manufacturer a sum corresponding to a certain number of working hours at a guaranteed high efficiency, that depend on the conditions of use. The amount of money for guaranteed working hours to be paid by the end user could decrease as the agreed time coverage of the contract increases.

Such a type of contract can then also foresee the coverage over a long time in the years, during which the components manufacturer will ensure the replacement of the components based on its own discretion, to ensure the high efficiency agreed with the customer.

Such contracting method has an advantage because the components/plants manufacturer will have to commit to furnish a reliable product, and the user does not undergo significant economic losses, due to low efficiency of his equipment.

With medium-long term guarantee contracts of this type, an effect of customer loyalty will additionally be achieved, discouraging the production of less expensive, but of low quality spare parts by third parties. The manufacturer will be able to improve the management of the inventory, that nowadays is essential to cope with urgent requests of replacement parts, and also the inventory of the end user can be reduced: it will be sufficient to keep a limited number of spare parts, to cope with accidental breakages not dependent on the wear.

The payment by the final user of the agreed amount of money could be divided into, e.g. periodic, installments over the whole time the contract remains in force, with economic and fiscal advantages.

Depending on the specific requests of the end user, by exploiting the statistical data derived from the information collected from the components on the field, the components manufacturer will also be able to identify and offer to the end user one or more recommended options.

In addition, the components manufacturer or the manufacturer can in particular offer to the end user specific service/guarantee contracts that contemplate scheduled maintenance interventions for the replacement of those conveyor components which, based on the obtained statistics, do not ensure that the conveyor operates at a predetermined level of efficiency, before coming to the definitive break of such components. The interventions can for example be scheduled based on the working hours of the components, keeping track of the conditions of use thereof (more critical conditions of use will generally require more frequent replacement interventions).

These and other aspects of the invention will be further discussed with reference to drawings, wherein like reference numerals represent like elements. It will be appreciated that the drawings are presented for illustrative purposes and may not be used for limiting the scope of the appended claims.

### BRIEF DESCRIPTION OF THE DRAWINGS

FIG. 1 schematically shows a possible use scenario of conveyors of articles that can be monitored by means of a monitoring system according to an embodiment of the present invention;

FIG. 2 shows an example of the information that can be stored and managed by the monitoring system according to an embodiment of the present invention; and

FIGS. 3A, 3B, 3C show schematically a portion of a conveyor of articles and a movement sensor according to an embodiment of the present invention.

FIG. 4 is a schematic perspective view of a portion of a chain conveyor that can be monitored through a system according to an embodiment of the present invention;

FIG. 5 shows an example of which information and data can be stored and managed by a concentrator and by an “RF tag” device associated therewith of the monitoring system according to an embodiment of the present invention;

FIG. 6 schematically shows a possible scenario of use of the monitoring system according to an embodiment of the present invention;

FIGS. 7A and 7B report in tabular form possible specifications of a conveyor component required by an end user; and

FIG. 8 reports in tabular form possible alternatives identified by the manufacturer of conveyor components exploiting the data retrieved through a monitoring system according to an embodiment of the present invention.

### DETAILED DESCRIPTION OF THE DRAWINGS

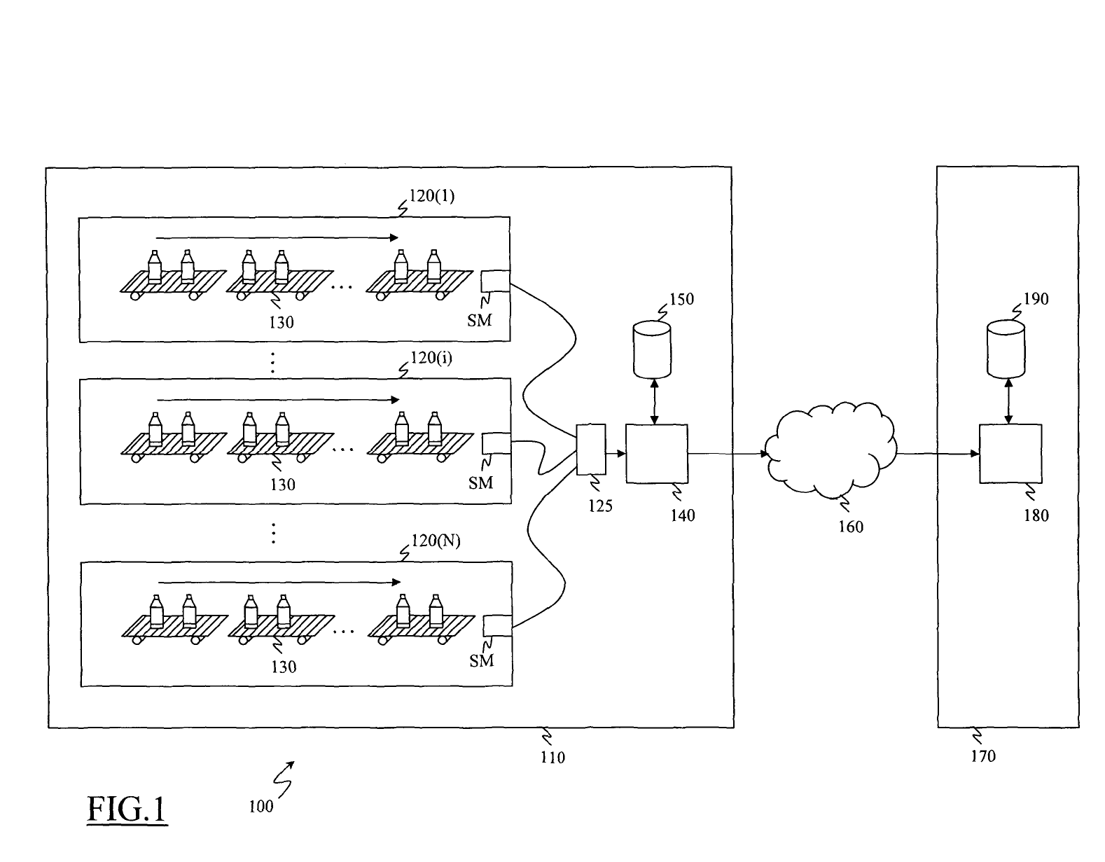

With reference to the drawings, in FIG. 1 there is schematically depicted a possible scenario 100 of use of conveyors of articles that can be monitored by a monitoring system according to an embodiment of the present invention.

Particularly, reference numeral 110 denotes a generic site (hereinafter referred to as the user plant) that makes use of conveyors of articles; for instance, the user plant 110 can be an industrial plant—like that of a food products packaging industry—or a luggage transport plant of an airport.

The user plant 110 includes a set of conveyor plants 120(i) (i=1, . . . , N) for the transport of articles like, for instance, bottles of drinks (mineral water, drinks and similar). Each conveyor plant 120(i) is formed of one or more conveyors 130, for instance of the chain type, comprising one or more transport chains. It is pointed out that the type of conveyor and the nature of the articles that it is intended to transport are not limitative to the goals of the present invention, which applies in general to whatever type of conveyor, independently from the nature of the articles to be transported.

More conveyors 130 arranged in series define, for each conveyor plant 120(i), a particular transport path to be followed by the articles.

According to an embodiment of the present invention, each conveyor plant 120(i) is equipped with at least one movement sensor SM, for instance formed by a proximity sensor capable of detecting the presence of objects in the close proximity thereof, without a physical contact. Particularly, the movement sensor SM is capable of determining if the conveyors 130 of the plant are or not in operation, i.e. if the transport chains are in movement or not. Through said movement sensors SM it is possible to determine the number of working hours actually performed by the conveyors 130 of each conveyor plant 120(i), as described in greater detail in the following.

According to an embodiment of the present invention, the movement sensor SM of a generic conveyor plant 120(i) is adapted to generate an electric signal from the time trend of which it is possible to deduce if the conveyors 130 of that particular conveyor plant 120(i) are in operation; for example, until the conveyors 130 are in operation, the corresponding movement sensor SM can generate a succession of voltage or current pulses—e.g. a pulse for every complete revolution made by a transport chain of the generic conveyor, or of a drive shaft that drives the transport chain—whereas when the conveyor 130 are idle, the signal can be zero. Naturally, it is pointed out that the type of signal generated by the movement sensor SM is not limitative to the goals of the present invention, being sufficient that the movement sensor generates a signal adapted to allow distinguishing an idle state from an operating state of the conveyor 130.

Particularly, for transporting the articles along the transport path defined by a generic conveyor plant 120(i), the simultaneous operation of all the conveyors 130 included in such conveyor plant 120(i) is in general necessary; in this case, it can be sufficient to provide a single movement sensor SM for each conveyor plant 120(i), because the stop of even a single conveyor 130 could determine the automatic stop of all the other conveyors 130 of the plant, and thus, by monitoring the operating state of one conveyor, it is possible to deduce the operating state of all the conveyors of the plant. In any case, nothing prevents from associating a movement sensor SM to each conveyor 130 of the plant, or at least one movement sensor to a group of two or more conveyors 130 of the generic plant 120(i).

The movement sensors SM of the various conveyor plants 120(i) are interfaced—through wired or radio connections—to one or more data acquisition cards 125 connected to a data processor (with functions of local server system) 140, for instance located within the user plant 110.

The generic data acquisition card 125 receives the signals generated by the different (one or more) movement sensors SM of the conveyor plants 120(i) and, based on them, it signals to the local server 140—for instance, at predetermined time intervals—which conveyors 130 among all those located in the user plant 110 are in operation at that moment.

The local server 140 can be associated to a local database 150, in which information is stored useful for the univocal identification of the various conveyors 130 associated with each movement sensor SM. In the local database 150 there are additionally stored the data received by the data acquisition card 125 relating to the operating state of the conveyors.

The local server 140 is configured to be able to forward the information contained in the local database 150 to the outside of the user plant 110 through an external communication network 160, like for instance a MAN, a WAN, a VPN, the Internet, a telephone network, for instance a public wired telephone network or mobile telephone network such as a cellular network, particularly a GSM/GPRS or UMTS network.

In this way, the data collected by the various movement sensors SM, together with the other information identifying the conveyors 130, can be made available to the site of a manufacturer 170 of the components of the conveyors 130. Particularly, at the site of the manufacturer 170 a central server 180 can be provided, remote with respect to the site of the user plant 110, which is connected to the communication network 160 and is adapted to collect and store the data provided by the local server 140 (or from more local servers 140, located at different user plants) in a centralized database 190.

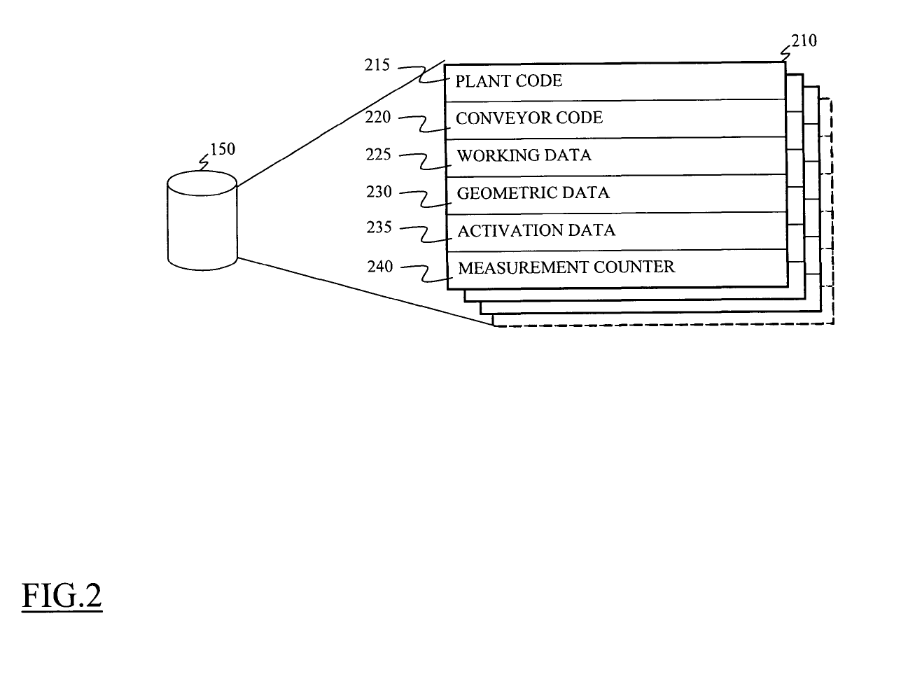

FIG. 2 schematically shows an example of the information that can be stored in the local database 150. As will be described in the following, by processing the information contained in the local database 150 and transferred to the central server 190, the components manufacturer 170 can obtain a reasonably approximated estimation of the useful operating life of the conveyors 130, particularly of the respective components subject to wear, like for instance the transport chains.

According to an embodiment of the present invention, the information stored in the local database 150 is for example arranged in a plurality of lists 210, each one associated with a corresponding movement sensor SM associated with a conveyor plant 120(i). Each list 210 contains identification and operating data related to the conveyors 130 associated with the corresponding movement sensor SM. Particularly, the list 210 can for instance contain the following data:
a first identification code, referred to as the plant code 215, that allows to univocally identify the conveyor plant 120(i) to which the movement sensor SM is associated; such code can for example be inserted in the list 210 during the installation of the conveyors 130 of the plant 120(i) in the user plant 110;
a second identification code, referred to as the conveyor code 220, that allows to univocally identify the conveyor(s) monitored by the movement sensor SM, for instance one or more codes that univocally identify the transport chains present in the plant 120(i); also in this case, such code can be inserted in the list 210 during the installation of the conveyors 130 in the user plant 110;
working data 225 that allow to identify the working conditions typical of the conveyor(s) 130 associated with the movement sensor SM; the working data can be inserted in the list 210 during the installation of the conveyors 130, and subsequently they can be varied by the user during the use. The working data 225 can provide indications concerning both the characteristics of the transported articles (like for instance the nature, the weight and the size of the articles), and the operating conditions of the conveyors 130 (such as the articles transport speed, and thus the speed of movement of the transport chains);
data related to geometric parameters 230, that allow to identify the geometric characteristics of the conveyor(s) 130 associated with the movement sensor SM, like for example the presence (and the possible number) of curves present in the transport path defined by the conveyors; also in this case, the geometric data can be inserted in the list 210 during the installation of the conveyors 130 in the user plant 110;
activation data 235, that allow to determine the date of first activation of the conveyor(s) 130 associated with the movement sensor SM; such data can for instance be inserted in the list 210 during the first activation of the conveyors 130.

The identification codes 215 and 220 and the data 225-235 described up to now are of a static type, because once inserted (typically, during the installation of the conveyor 130) their values remain nearly unchanged (with the possible exception of the working data 225, that can be subsequently modified by the user, in consequence of variations in the conditions of use of the installed conveyor).

According to an embodiment of the present invention, the list 210 also contains further data 240, for instance a measurement counter, adapted to provide, or from which it is possible to derive an indication regarding the total working time of the conveyors 130 associated with the movement sensor SM, particularly the overall time, for instance measured from the date of first activation, that such conveyors 130 have spent in operation, i.e. with the respective transport chains in movement. The counter 240 is a dynamic value, that is updated by the local server 140—for example, at predetermined time intervals—by monitoring the signal generated by the corresponding movement sensor SM and acquired by the data acquisition card 125. Particularly, according to an embodiment of the present invention, until the conveyors 130 associated with the movement sensor SM are in operation, and the respective chains are in movement, the movement sensor SM generates voltage or current pulses that are provided to, and interpreted by the data acquisition card 125 and until a signal is received by the movement sensor the counter 240 is continually increased by the local server 140, for example with an update frequency determined by a clock signal. When the conveyors 130 associated with the movement sensor SM are stopped, the data acquisition card 125 no longer receives signals, e.g. voltage or current pulses, from the movement sensor SM, and consequently the local server 140 stops increasing the corresponding counter 240. As soon as the conveyors 130 are again put in operation, the counter 240 restarts to be increased.

According to a preferred embodiment of the present invention, the list 210 can also include further data, that allow, for instance, to record the dates and the modes of possible maintenance or revision interventions, with possible replacement of components (e.g. of the transport chains or of parts thereof) performed on the conveyors associated with the movement sensor SM.

By reading of the various lists 210 stored in the local database 150 of the local server 140, it is therefore possible to obtain different indications, concerning for instance:
the conveyor plants 120(i), and particularly the conveyors 130, active (in operation) at a certain time;
the total working age (intended as the time actually passed in operation beginning from the installation) of each conveyor 130;
the actual time lapsed from the last maintenance/revision intervention performed on each conveyor 130;
the working conditions of the conveyors 130;
the geometric characteristics of the conveyors installed in the user plant 110.

According to an embodiment of the invention, the manufacturer 170 of the components of the conveyors 130 collects from the local server(s) 140, located at user plants 110 in which the conveyors have been installed, through the connection over the communication networks 160, the information contained in the respective local database 150, storing it in the centralized database 190.

Accordingly, thanks to the fact that the components' producer 170 can always have updated data related to the components installed in the conveyors on the field, by suitably analyzing such data it can obtain a statistic about the reliability in time of the components, keeping track of the different working conditions.

For example, having available information about the conditions of use of the various conveyors 130, like the number of working hours and the conditions of use (e.g. the type of load and the geometric characteristics of the conveyors), the components' producer 170 can determine a trend of the efficiency of the conveyor 130 during the time. For example, based on the collected data it is possible to build charts or diagrams of the trend of the efficiency of the conveyor, particularly of its components subject to wear like the transport chains and their constitutive parts, as a function of the time and of the type of load.

This for instance allows the components manufacturer to establish in advance the suitable times for the interventions of maintenance/replacement of the conveyors components, so as to avoid reaching the breakage of the critical components.

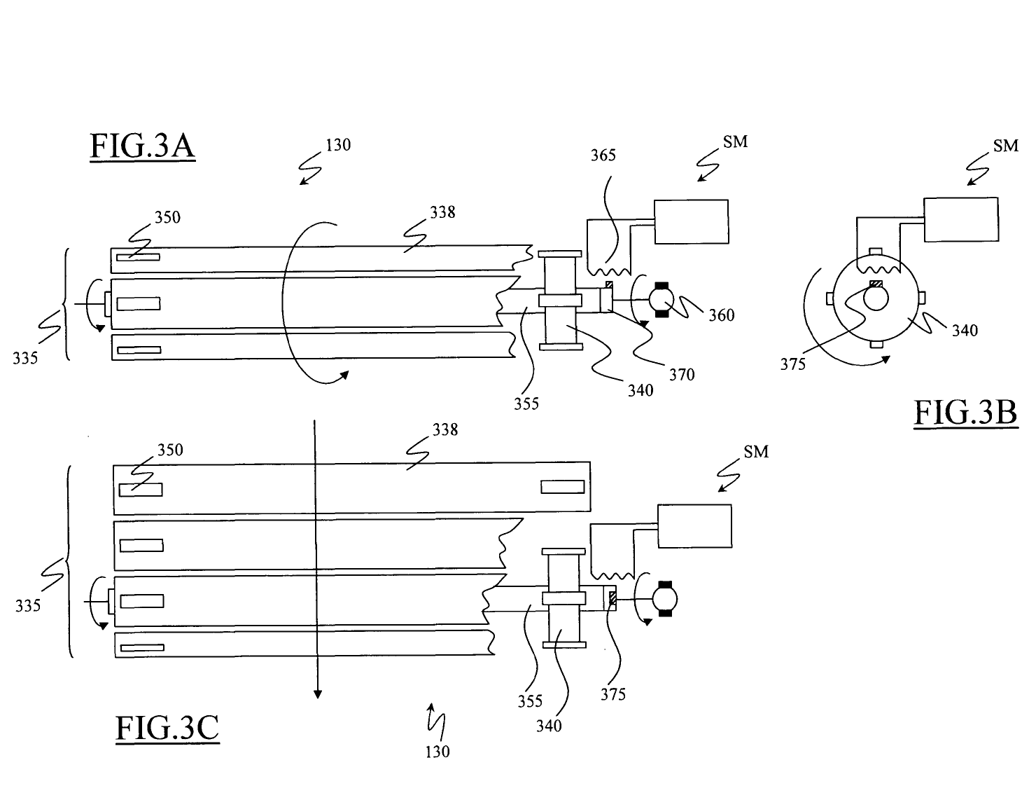

According to an embodiment of the invention, a movement sensor SM that can be used for monitoring the operating state of a conveyor plant 120(i) can be a inductive type sensor, as shown in FIGS. 3A, 3B, 3C and described in the following.

Particularly, FIG. 3A is front view (with partially removed parts) of a portion of the conveyor 130 that is coupled to the movement sensor SM. FIG. 3B shows the same portion of the conveyor 130 in side view, while FIG. 3C shows said portion of the conveyor 130 in top view.

In the considered example, the conveyor 130 includes a respective transport chain 335 formed of a plurality of chain links 338 hinged to one another, for instance by means of pins, to define a substantially plane surface for the support of the articles to be transported. The transport chain 335 is driven by suitable driving means, comprising for instance an electric motor and respective transmission means, and in use it is assumed that it moves along the direction of the arrows visible in the figure. For example, the transport chain 335 is caused to move by drive pinions 340 that engage suitable seats 350 provided in each chain link 338. The pinions 340 are caused to rotate by a drive shaft 355, in turn driven by a motor 360, e.g. electric. The transport chain 335 slidably abuts on respective guide profile members (not shown) in a material having low friction coefficient, mounted on respective side supports (also not shown) of a frame of the conveyor.

According to the considered example, an end of the drive shaft 355 is provided with a collar 370 having a protruding metallic tooth 375, and the movement sensor SM is provided with an inductive element 365, positioned in correspondence of the collar 370.

During the rotation of the drive shaft 355, i.e. during the operation of the conveyor 130, the metallic tooth 375 of the collar 370 rotates integrally with the shaft 355. When the metallic tooth 375 comes in proximity of the inductive element 365, the inductive element 365 is run through an induced electric current, which is detected by the movement sensor SM. Accordingly, until the conveyor 130 is in operation, i.e. until the drive shaft 355 is in rotation and the chain 335 is in movement, the movement sensor SM is run through by pulses of induced current; particularly, each current pulse is generated when the metallic tooth 375 comes to be in proximity of the inductive element 365. The electric signal thus generated is sent to the data acquisition card 125, to be used in the way described in the foregoing.

In a variation of the embodiment just described, the function of the metallic tooth 375 could be performed by one of the pins that hinge the links 338 of the chain 335 to one another, providing on an end of the pin a suitable element adapted to cooperate with the inductive element 365.

An alternative solution to detect the movement of the conveyors 130 may relate to providing movement sensors SM of optical type, for instance using video cameras. Naturally, in this case a suitable interface processing software is necessary for the image recognition.

A further alternative solution to detect the state of movement of the conveyors 130 may relate to detecting the supply current of the motors 360 that cause the conveyors 130 to move—for example through amperometric probes for the measurement of alternate currents—since the flow of electric current in the motor 360 indicates that the conveyor 130 is in operation.

According to an embodiment of the present invention, the monitoring of the conveyors 130 of the transport plants 120(i) can be made easier through the use of tag means for the univocal identification of the conveyors 130 and of the respective components.

Particularly, by using such tag means it is easier to record in the local server 140, during the installation, the position of the conveyor 130 within the user plant 110, the fact that the conveyor belongs to a particular transport plant 120(i), and the identification of which movement sensor SM is associated with the conveyor.

For example, each conveyor 130 or each conveyor component, e.g. the individual links of the transport chain, could for instance be provided with a suitable tag laser marking, e.g. showing a unique code to which the identification data of the conveyor 130 correspond.

A more advantageous and effective solution may relate to using as a tag a barcode laser marking or an electronic transponder device of the type used in Radio Frequency identification systems, like for instance in those systems known as “Radio Frequency IDentification” (“RFID”) systems. In this case, it is possible to associate with the barcode, or directly record into the RFID device, the various identification data of the conveyor 130 in efficient way. The data stored in the RFID type devices and the barcodes can in particular be read by using special portable reading devices.

During the installation of a new component in a generic conveyor (for instance, a new transport chain), the data corresponding to the tag of the new component can be directly read by a portable reading device, and put in the local database in combination with that conveyor. During the replacement of the component (for instance, once the useful working life is reached), it is possible to verify very easily that the replacement has been effected correctly by checking the tag of the replaced component.

The reading of a wrong tag or the total absence of tags on the components of the conveyors covered by guarantee of the producer can determine the lapse of the contractual obligations agreed upon.

Naturally, to the solution described above one skilled in the art can, in order to satisfy contingent and specific needs, bring several changes and variations.

For instance, the movement sensors could be of an evolved type, and include circuitry adapted to interpret the signals generated by the monitoring of the conveyors; in this case, the data acquisition card could be replaced by a simple network interface card, wired or wireless, since data already processed and interpreted would be provided to the local server.

According to an alternative embodiment of the present invention, the local server 140—and the respective local database 150—can be replaced by a Programmable Logic Controller (“PLC”) coupled to a GSM-type data transfer unit, for instance integrated in the same PLC. Particularly, according to this embodiment, the PLC is coupled to the movement sensors SM to receive the electric signals indicating the state of movement of the various conveyors 130. Periodically, the GSM unit of the PLC sends to the central server 180, through the external communication network 160, one or more SMSs that include information concerning the working hours of the various conveyors 130. Particularly, in each SMS one or more codes are included that allow identifying the conveyors 130, and, for each identification code, the number of working hours of the conveyors associated with the last dispatched SMS. For example, based on the signals received from the movement sensors SM, the PLC keeps track of the number of working hours of the conveyors 130 in the time interval from the last dispatched of SMS. Each time that an SMS is received, the central server 180 increases a series of counters—each one corresponding to a certain identification code of a conveyor 130—stored in the centralized database 190, adding to each of them the respective number of working hours specified in the SMS. In this way, from each counter it is possible to deduce the total number of working hours of each conveyor 130.

According to this embodiment, thanks to the fact that the local server 140 is no longer necessary, the maintenance required by the monitoring system is drastically decreased.

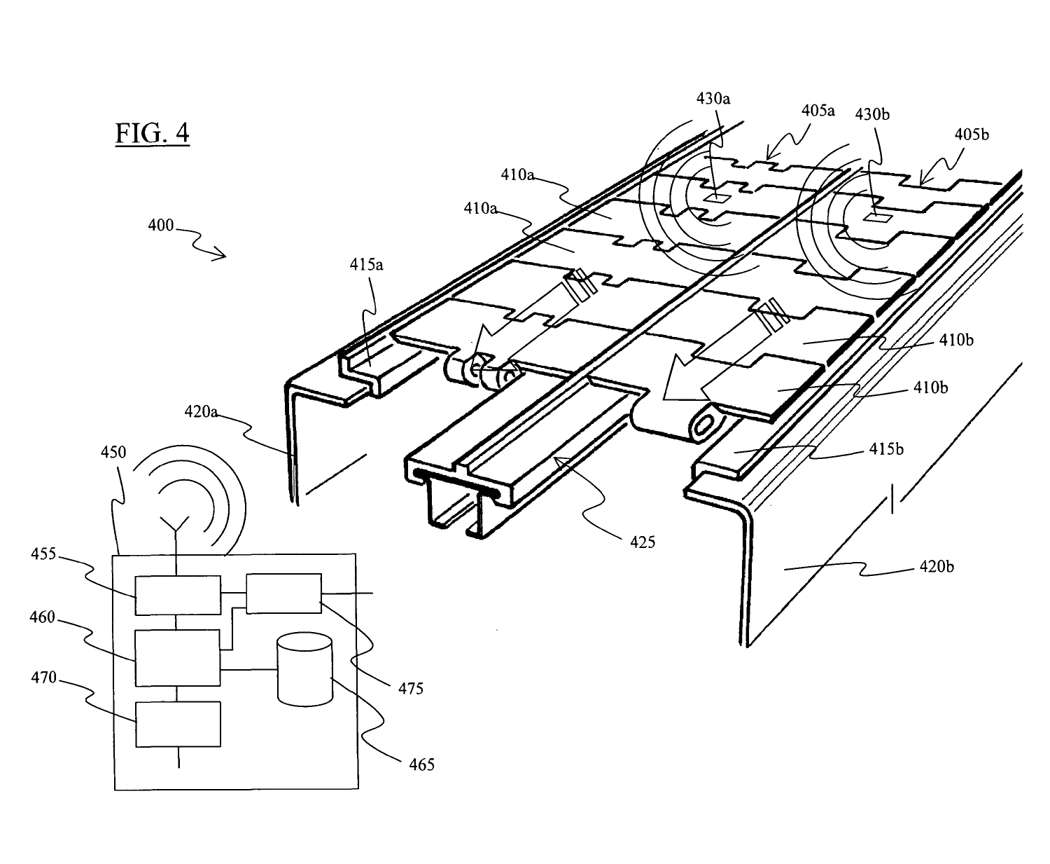

In FIG. 4 there is schematically depicted a short section of a conveyor of articles 400, particularly a chain conveyor, comprising for instance a pair of transport chains 405a and 405b (that, in the shown section, are parallel to each other), for the transport of articles like, for instance, bottles of drinks (mineral water, drinks and similar), not shown in the drawing. It is pointed out that the type of conveyor and the nature of the articles to be transported are not limitative for the purposes of the present invention, which applies in general to whatever type of conveyor, independently from the nature of the articles to be transported. Particularly, it is pointed out that, although in the following the invention will be described by way of example in connection with the monitoring of the transport chain of the conveyor, this is not to be intended as a limitation of the present invention, that in principle can be applied to the monitoring of any component of the conveyor, for instance, but not limitatively, driving cogwheels and pinions of the transport chains.

The chains 405a and 405b are each made up of a plurality of chain segments, each of which is in turn constituted by a plurality of chain links 410a, 410b, respectively, hinged to one another to define a substantially plane, smooth surface for the support of transported articles. The transport chains 405a and 405b are put into movement by suitable driving means (not shown because known per se and not relevant for the purpose of understanding the invention embodiment here the considered), and in use it is assumed that they run along the direction of the arrows visible in the figure. Each one of the chains 405a and 405b slidably abuts, in correspondence of a first outer external edge thereof, a respective guide profile 415a, 415b, in a material having low friction coefficient, which is mounted on a shoulder of a respective side support 420a, 420b. Centrally, a chain-guiding element 425 is provided, that extends along the transport path and on which the inner edges of the chains 405a and 405b abuts.

According to an embodiment of the invention, for the remote monitoring of the conveyor 400, particularly of the transport chains 405a and 405b and of the respective links 410a, 410b, a Radio Frequency (RF) identification system is employed. RF identification systems are known and exploited in other technical fields, and they are generally identified as “Radio Frequency IDentification” (“RFID”).

An RFID system uses radio waves to read and write data from/into electronic supports called “transponders” (contraction of the term “transmitter-responder”) or RF “tags”. The data stored in the RF tags are read through suitable radiofrequency reading devices.

The RFID systems are normally employed for the remote automatic identification of objects. Particularly, on every object that has to be remotely identified, a respective RF tag is placed; the identification can be performed automatically in remote way by a suitable reading device, since each RF tag is capable of radio transmitting the data contained therein when polled by the reading device.

Referring back to the chain conveyor 400 shown in FIG. 4, according to an embodiment of the invention, each chain 405a, 405b, particularly at least a chain segment in each of the chains 405a, 405b, preferably two or more segments of each chain, and even more preferably each segment, includes at least one chain link 410a, 410b that includes or has applied thereto a respective RFID device—i.e. an RF tag—430a, 430b. The RF tags 430a, 430b applied to the chain links 410a, 410b are adapted to store in a memory integrated therein (not shown in the figure) data adapted to univocally identify the segment of chain to which the link to which they are applied belongs, and data related to the operating state of the links and/or of the segments of chain to which they belong, as will be described in greater detail in the following of the present description.

Particularly, according to an embodiment of the invention, the RF tags 430a, 430b may consist of an integrated circuit chip, connected to an antenna, made for instance of conductors printed or deposited onto a thin plastic sheet.

According to an embodiment of the invention, the RF tags 430a, 430b are of passive type, i.e. not provided with an own power supply source, for instance not provided with a battery, and they are supplied by the current induced by the electromagnetic field produced by a communication device adapted to communicate with the RF tags; such communication device, when it polls the generic RF tag, irradiates an electromagnetic field, that supplies to the polled RF tag the power necessary to receive the signals from the communication device, to read the data stored therein, and to transmit the read data to the communication device, as well as to receive and store into the integrated memory the data received by the communication device.

In an alternative embodiment, the RF tags may be of active type, i.e. provided with their own power supply source, and for instance they may be supplied by a respective dedicated battery.

Advantageously, the RF tags 430a, 430b can be immersed in resin so as to be made integral with the links 410a, 410b of the transport chain. However, other ways for applying the RF tags to the links of the chain are possible, for instance by using an adhesive. Preferably, the RF tags are applied to the links of the chain in such a way that, in use, they do not enter into contact with the transported articles.

The communication devices with the RF tags include one or more RFID interface unit 450 (in the following of the description simply referred to as “concentrators”) for reading/writing data from/into the RF tags associated with the links of the transport chains. The concentrator(s) 450 is for instance placed near the chain conveyor 400, or it is mounted to the frame of the conveyor.

The generic concentrator 450 has the function of interfacing with the RF tags 430a, 430b applied to the links of the transport chains of the conveyor 400, for the purpose of reading and decoding the data stored in the RF tags 430a 430b. Additionally, according to an embodiment of the present invention, the generic concentrator 450 is capable of updating the data stored in the RF tags through radio frequency data writing operations.

The generic concentrator 450 can also be able to perform at least a preliminary processing of the data read from the RF tags 430a, 430b embedded in the links of the transport chains, to derive information useful for the monitoring of the operating conditions of the chain conveyor 400.

For simplicity of representation, FIG. 4 shows only one concentrator 450 adapted to communicate via radio with the RF tags 430a, 430b applied to the links of the chains of only one conveyor (particularly, the chain conveyor 400); nevertheless, nothing prevents that a single concentrator 450 is capable of interfacing with the RF tags provided on the chain links or other components of two or more different conveyors. Particularly, the number of RF tags that can communicate with the generic concentrator 450 depends in general on the distance between the concentrator 450 and the RF tags applied to the components of the conveyor(s). Typically, depending on the technology used for the realization of the RF tags, the maximum transmission range of an RF tag can vary from half a meter to distances of the order of ten meters.

The generic concentrator 450 is equipped with hardware resources that allow it performing all the operations necessary for interfacing with the RF tags 430a, 430b, for the reading and/or writing data from/into the RF tags, and for the communication of such data to other devices, like a remote data processor. In embodiments of the invention, the concentrator 450 can additionally be equipped with hardware/software resources adapted to allow it to perform a (possibly preliminary) processing of the data read from the RF tags with which it is intended in use to communicate. For instance, the concentrator 450 includes a transmission/reception module RTX 455, comprising logic/analogue control circuits adapted to perform the data writing/reading operations, coupled to a processing unit 460, for instance a microprocessor or a microcontroller, adapted to execute a program that has the function of controlling all the operations performed by the concentrator. The concentrator 450 can include a database 465, adapted to store the data that originate from the RF tags 430a, 430b, or to write data into the RF tags 430a, 430b that in use communicate with the concentrator 450, particularly data that identify the RF tags 430a, 430b and the transport chain 400 to which they are applied.

The concentrator 450 can additionally interface, for instance by means of network interface card 470, with a wired or wireless data network, for instance a local Ethernet network installed at the premises of the user where the chain conveyor 400 is located, and/or a wider, private or public data network, external to the plant, for instance a MAN (Metropolitan Area Network), a WAN (Wide Area Network), a VPN (Virtual Private Network), or the Internet.

Through the local network, or directly through a suitable connection (for example a USB—Universal Serial Bus—connection, a FireWire connection, a Bluetooth connection, a ZigBee connection, a NFC—Near Field Communication—connection, a WiFi connection, or other type of medium or short range, wired or wireless connection) the concentrator 450 is able to interface with a data processor (not shown), for instance a Personal Computer, a laptop, a palmtop, a “smartphone” with installed a software suitable to communicate with the concentrator 450; in such a case, the processing and the storage of the data can be done by the data processor, rather than directly by the concentrator 450; the processing capabilities of the processing unit 460 of the concentrator 450 and the amount and nature of information stored in its database 465 can thus be relatively limited.

All the circuit blocks that make up the concentrator 450 are supplied by a supply circuit 475, that can include a battery or be provided with a connection for receiving the electricity main.

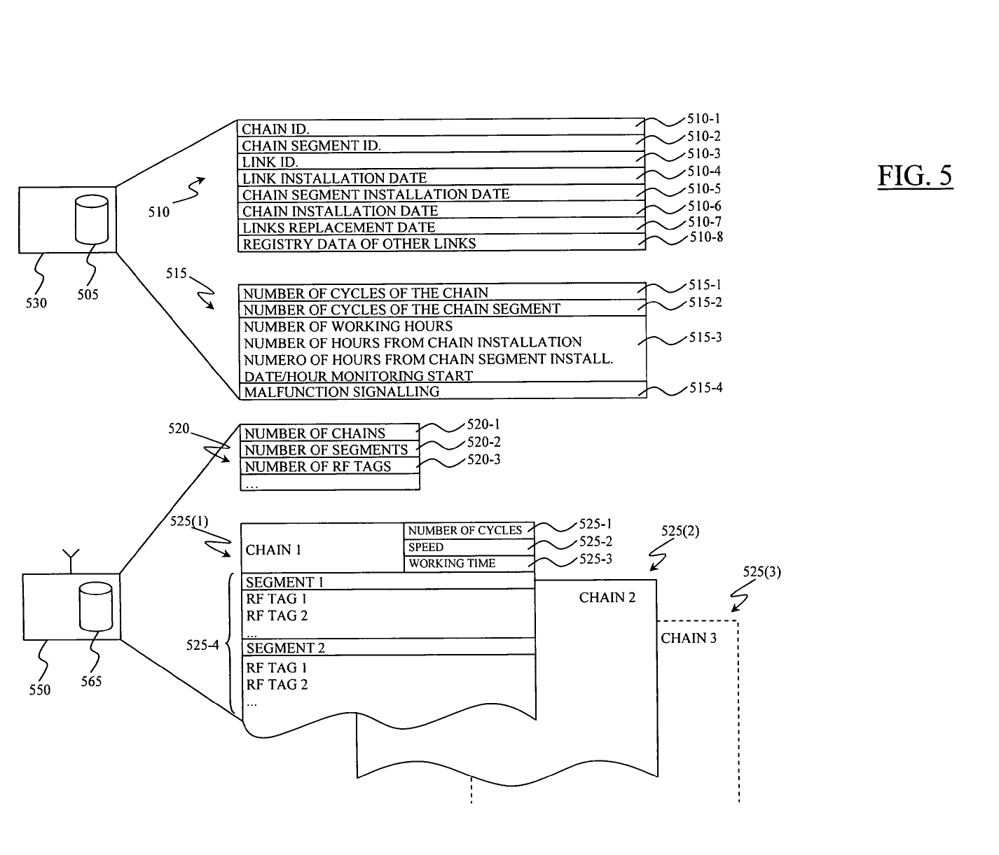

FIG. 5 shows an example of information can be stored and managed by a generic concentrator 550 and by a generic RF tag 530 with which the concentrator 550 in use communicates.

According to an embodiment of the invention, the RF tag 530 includes an integrated memory 505, for instance an EEPROM or Flash memory, in which the stored data are arranged according to two different lists 510 and 515.

A first list 510, hereinafter referred to as registry data list or, more concisely, registry list, contains registry data identifying the chain link on which the RF tag 530 is installed. Such registry data can for example be stored in the registry list 510 in the production phase of the chain link, by the manufacturer of conveyor components, and/or subsequently, for instance during the manufacturing of the transport plant or during the operating life of the conveyor. The registry data list 510 can for instance contain:
a first identification code 510-1 that allows to univocally identify the chain to which the link belongs,
a second identification code 510-2 that allows to identify the chain segment to which the link belongs, within the global chain,
a third identification code 510-3 that allows to determine the position of the link within the chain segment to which it belongs.

By reading the registry data list 510, it is possible to easily and univocally identify, among several conveyors that may be present in the site of the end user, in which conveyor, in which chain, in which chain segment and where, within the chain segment, the chain link provided with the RF tag is located.

Additionally, in the registry data list 510 temporal indications (for instance dates) may be stored, that allow reconstructing the history of the chain link and of the respective chain segment corresponding to the RF tag 530. Particularly, the registry data list may contain:
a fourth code 510-4 that identifies the installation date of the RF tag 530 on the corresponding chain link (and thus the date of production of the link),
a fifth code 510-5 that identifies the installation date of the corresponding chain segment in the chain of the conveyor,
a sixth code 510-6 that identifies the installation date of the whole chain on the conveyor,
and a series of codes 510-7 that identify if and when the links belonging to the chain segment have been replaced by substitutive links.

Some of the data included in the registry data list 510 can be non-modifiable; an alteration of such data can be necessary when the link/chain segment on which the RF tag 530 is installed is removed and/or installed elsewhere (in this case, the data that identify the position of the link are updated), or when the links of the chain segment are replaced.

According to an embodiment of the present invention, the registry data list 510 of each RF tag 530 also includes the registry data 510-8 identifying the other RF tags that are installed on the links belonging to the same chain segment, or, according to a further embodiment of the invention, on the links belonging to the other segments of the same chain. In this way, by observing the whole set of the registry data lists of the RF tags belonging to a chain segment it is possible to reconstruct the history of all the chain links, keeping track of all the dates of replacement and installation.

A second data list 515, referred to as dynamic data list, is instead devoted to the storage of data that are calculated during the operation of the conveyor by the concentrator 550 interfacing with the RF tag 530, or by a data processor connected to the concentrator 550, and that are written into the integrated memory of the RF tag 530; the data stored in the dynamic data list 515 evolve dynamically in time. For instance, as will be described in more detail in the following of the present description, the data included in the dynamic data list 515 are updated periodically by the concentrator 550. The dynamic data list 515 may in particular include:
a first code 515-1 that identifies the number of cycles (complete revolutions) currently completed by the chain containing the segment that includes the RF tag 530 (for example, starting from the installation date of the chain on the conveyor),
a second code 515-2 that identifies the number of cycles (complete revolutions) currently completed by the chain segment that includes the link with the RF tag 530 (starting from the installation date of the chain segment in the conveyor chain),
data 515-3 related to the overall number of working hours of the chain, the number of hours from the installation of the chain on the conveyor, the number of hours from the installation of the chain segment in the corresponding chain,
a third code 515-4 that identifies the date and the time of start of the survey performed by the concentrator 550.

The values of the data in the dynamic data list 515 can be measured by the concentrator 550 in the following way. Particularly, according to an embodiment of the present invention, during the operation of the chain conveyor, the concentrator 550 sends suitable radiofrequency poll signals, that are received by the RF tags 530 present on the links of the conveyor and which, at that time, are at a distance from the concentrator 550 within the maximum reception range; thus, the RF tags 530, stimulated by the poll signals, identify themselves at the concentrator 550, answering thereto by sending the data included in the registry data list 510. In this way, the concentrator 550, or a data processor connected thereto, can derive useful information that allow to automatically measure the number of cycles (complete revolutions) made by the chain link on which the RF tag 530 is installed. For example, by suitably positioning the concentrator with respect to the body of the chain conveyor, so that the RF tag 530 come to be within the receiving range with the concentrator 550 in only one point during its movement along the path defined by the chain, it is possible to determine the number of complete revolutions performed by the link including the RF tag (and, therefore, the number of revolutions completed by the chain segment and by the chain as a whole) by simply counting the number of answers received by that specific RF tag 530. By counting the number of seconds elapsed between two successive passages of a link containing a certain RF tag, it is possible to deduce the average advancement speed of the transport chain. The concentrator 550 can also deduce the position of the RF tags 530 with respect thereto by analyzing the strength of the answer signals received from the RF tags 530, and exploit this information to calculate the number of completed revolutions.

According to an embodiment of the invention, in the dynamic data list 515 possible signalling of breaks or malfunctions may also be stored (field 515-4 in the figure); for instance, in case a break is signalled (e.g., through the manual signalling of an employee to supervises the operation of the conveyor), the concentrator 550 acts on the RF tags 530 corresponding to the chain that has suffered the break, storing thereon the date of the signalling and, possibly, a code identifying the type of event that caused the break. In particular, it can be foreseen that track is kept, through storage on the RF tags 530, of the number of stops of the conveyor, and/or of their frequency (for instance, in terms of number of stops per hour); such stops can depend on accidental falls of the transported articles, and the probability that a stop occurs due to a fall of the transported articles increases with the wear of the transport chain.

Passing now in greater detail to the concentrator 550, according to an embodiment of the present invention, a portion of the database 565 contained therein is adapted to store data arranged according to two different lists 520 and 525.

Particularly, in a first list 520, referred to as global list, information of general nature is stored about the set of all the components of the conveyor(s) monitored by the concentrator 550. For instance, the global list 520 can contain:
data 520-1 related to the number and to the identification codes of the transport chains that are monitored by the concentrator 550,
data 520-2 related to the number and to the identification codes of the chain segments that make up the chains, and
data 220-3 related to the number and to the identification codes of the individual RF tags 530 present in the links of the segments.

According to an embodiment of the present invention, the second list 525, referred to as chains list, comprises a set of sub-lists 525(i) (i=1, 2, . . . , N, where N is the number of transport chains monitored by the concentrator 550), each of which is dedicated to the storage of data deducible from the monitoring of the RF tags 530 of a particular chain. For instance, the generic sub-list 525(i), corresponding to the chain “i” (the identification of such chain can be made through the identification code present in the registry list 510 of the RF tags 530 belonging to such chain), can include:
a first code 525-1 that identifies the number of cycles (complete revolutions) completed by the chain,
a second code 525-2 that identifies the moving speed of the chain (as mentioned in the foregoing, the value of the speed can be calculated by the concentrator 550 or by a data processor connected thereto based on the time taken for completing a predetermined number of revolutions of the chain), and
a third code 525-3 that indicates the number of working hours of the conveyor on which the chain is mounted.

Additionally, the generic sub-list 525(i) includes, for each segment of the chain, a list 525-4 of the various RF tags 530 corresponding to the segments; in particular, in such list 525-4, for each RF tag 530 there are stored a copy of the registry data list 510 and of the dynamic data list 515 of that particular RF tag 530.

It is pointed out that the data contained in the database 565, instead of or in addition to being stored in the generic concentrator 550, can be stored in a data processor connected to the concentrator, and/or at a remote server, located for example at the premises of the manufacturer of conveyor components, as will be described more clearly in the following.

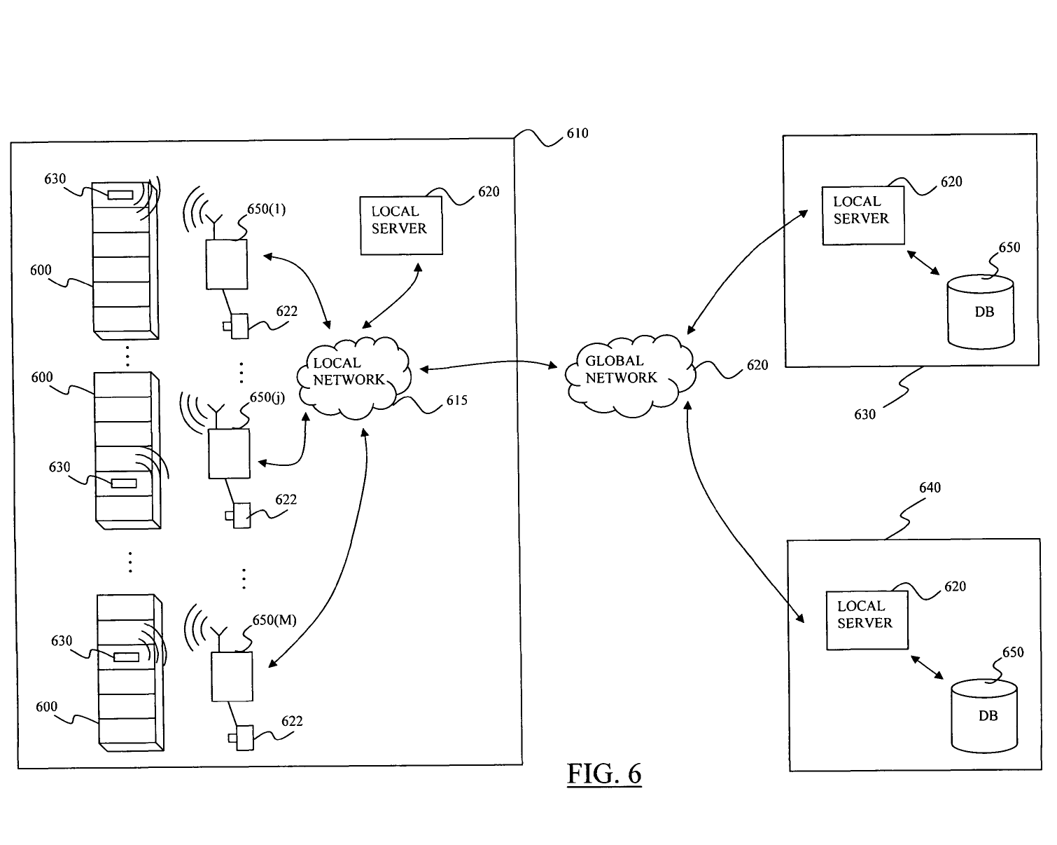

Passing now to FIG. 6, there is schematically illustrated a possible scenario 600 of use of the remote monitoring system according to an embodiment of the present invention.

Reference numeral 610 denotes a generic plant (hereinafter referred to as user plant) that makes use of chain conveyors; for instance, the user plant 610 can be an industrial plant or a luggage transport plant of an airport. In other words, reference numeral 610 denotes a production site of the end user of conveyor(s).

The user plant 610 includes a plurality of N chain conveyors 600(i) (i=1, 2, 3, . . . , N), and a plurality of M concentrators 650(j) (j=1, 2, 3, . . . , M), arranged at suitable distances with respect to the chain conveyors 600(i), for instance mounted on the conveyor frames.

The concentrators 650(j) of the user plant 610 are connected to a local network 615, for instance, a wired or wireless intranet of the end user, e.g. a WiFi network, to which a local server processor 620 is connected. During the operation of the user plant 610, or when the chain conveyors 600(j) are active, they are monitored by the concentrators 650(j), that interface and communicate with respective RF tags 630 placed on the links of the conveyors.

The monitoring provides for the exchange of data and the update of the lists contained in the database 665 of the concentrators 650(j) and in the memories integrated in the RF tags 630, as described in the foregoing. As already pointed out, the concentrators 650, instead of locally building the database 665, can transfer the data read from the RF tags to the local server 620, in such a case the database 665 will reside at the local server 620.

Since all the concentrators 650(j) of the user plant are connected to the local server 620 through the local network 615, it is possible to view—by means of the local server 620 or by means of further terminals, not shown in the figure—the data included in the various global lists 620 and in the chains lists 625. In this way, the end user can have a real-time detailed picture of the operating situation of all the chain conveyors 600(i) (and of their components).

For instance, through the local server 620 it is possible to obtain information about:
the number of active conveyors;
for each conveyor, the number and the identity of the transport chains, of the chain segments and of the chain links in movement;
the number of complete revolutions (cycles) made by each link of the generic conveyor chain;
the overall operating life (intended as the working time effectively lapsed starting from the installation) of the generic conveyor chain, of a particular segment or of a particular chain link;
the effective time lapsed from the last in situ check performed by specialized personnel (this issue will be treated in greater detail in the following of the description).

The user plant 610 can additionally include a series of signalling posts 622, for example in a number equal to the number of the concentrators 650(j), each of which is coupled to a specific, respective concentrator 650(j). Through such signalling posts 622, the employees supervising the operation of the chain conveyors 600(i) can signal possible failures (e.g., falls of transported articles, breaks of the transport chains) by actuating suitable commands present on each signalling post 322; the signalling of the failure is sent to the corresponding concentrator 650(j), that forwards it to the local server 620 and stores the date of the signalling (and, possibly, the nature of the failure) in the dynamic data list 615 of the RF tags 630 of the chain interested by the failure. Naturally, the concepts of the present invention can be applied also when the signalling posts 622 are in different number with respect to concentrators 650(j), and they operate in a different way.

According to an embodiment of the present invention, the data and the information (or at least part thereof) received by the local server 620, and/or the data directly read by the concentrators 650(j), can be automatically forwarded to the outside of the user plant 610, through an external network 625, such as for instance a MAN, a WAN, a VPN, the Internet, a telephone network, for instance the public wired telephone network or a mobile telephone network like the cellular network.

In this way, the results of the monitoring performed by the various concentrators 650(j) can be made available remotely both to the manufacturer 630 of the conveyor components (for instance, the manufacturer of the transport chains), and to the manufacturer 640 of the chain conveyors 600(i).

Particularly, at the premises of the components producer 630 a local server processor 645 can be provided, located remotely from the premises of the user plant 610, which is connected to the global network 625 and is adapted to receive the data provided by the local server 620 and/or directly by the concentrators 650(j) of the user plant 610; the local server 645 can store the data included in the various global lists and chains lists of the concentrators 650(i), for example in a suitable database 650.

At the premises of the manufacturer of components 630 it is thus possible to keep track—practically in real time—of the real conditions of the transport chains, of the chain segments and of the single links, totally in remote way, without having the necessity to personally go to the user plant 610.

If, upon analyzing the data received from the premises of the end user, the necessity of an in situ intervention is deduced, the producer's premises 630 can alert its own technician or team of technicians, that is personally sent to the user plant 610. For instance, the local server 645 can implement a functionality adapted to automatically alert the technician(s) in charge of the intervention, for instance sending an SMS. Particularly, and merely by way of example, by monitoring the frequency of the stops of a generic conveyor (as described in the foregoing, such information is stored in the RF tags and in the concentrator) it is possible to establish when it is necessary to replace a transport chain or one segment thereof. Indeed, a too high stops frequency probably means a repeated fall of transported articles as a consequence of the excessive wear of the transport chain: by comparing the stops frequency with predetermined values, it is thus possible to determine when it is preferable to replace the transport chain, or one or more its segments, so as to avoid that the conveyor continues to work in conditions of lower and lower efficiency.

By exploiting this solution, it is possible to substantially improve the maintenance procedure of the components of the conveyors 600(i), with a saving both in terms of costs and in terms of time.

Thanks to the fact that the monitoring is performed remotely, the interventions of the team of technicians are limited only to the really necessary cases; it is in fact possible to plan in advance the interventions of the teams of technicians, from the premises of the producer 630, exploiting the information received from the concentrators 650(i) of the user plant 610. For example, it is possible to decide to perform in situ checks only when certain links of the transport chains have reached a predetermined operating age, in terms of working hours, or when they have made a certain number of cycles.

Additionally, the components producer, based on the data gathered from the field, may have an effective statistic about the operating conditions/life of its products at the various customers that exploit this monitoring solution; such statistic information can be exploited for improving the components production quality or the quality of the offered services (for instance, offering an exclusive guarantee of the product). For example, by monitoring, during the time, the frequency of the stops of the conveyors on the field, it is possible to obtain a statistic of the operating life of the conveyors components, in known working conditions, and particularly it is possible to determine, for the various conveyor components, how many working hours they can sustain while ensuring certain efficiency levels of the plant.

According to an embodiment of the invention, when the team of technicians performs a check of, and/or replaces a component (for instance, a link), the date of the check and/or replacement is notified to the system, for instance storing such date in the integrated memory of the RF tags 630 through a portable RFID writing device. In this way, it will be possible to keep track of all the checks and/or replacements made on the chain together with their dates. Alternatively, the concentrator 650, or a data processor connected thereto, may, the first time that the RF tag 630 applied to the replaced link or chain segment is polled, automatically recognize the occurred replacement, and automatically update the information stored in the database 665 and in the RF tags 630 of the other chain links; the maintenance operator may, through a portable terminal, store on the RF tag of the replaced chain segment the cause of the replacement.

Thanks to the fact that the generic RF tag 630 also stores data related to the other RF tags of the chain, a possible loss of the data included in the database 665 is not an irreversible event: the database can be reconstructed.

In a totally similar way, the site 640 of the manufacturer of the transport plant can include a local server processor 660, remote with respect to the premises of the end user, which is connected to the global network 625 so as to receive the data provided by the user plant 610, and the data included in the various global lists and chains lists of the concentrators 650(i) can be stored in a dedicated database 665. Thus, the same considerations made in respect of the components manufacturer applies to the conveyors manufacturer.

Moreover, an important aspect resides in that thanks to the fact that the components' manufacturer can have data up-to-date related to the components installed on the conveyors on the field, by properly analyzing such data a statistics about the reliability in time of the components can be obtained, keeping track of the different operating conditions.

For example, by being able to univocally identify the individual components, for instance the individual links or chain segments, and having information about their conditions of use, like for instance the number of working hours, the speed of movement the chain, the number of malfunctioning signallings from the final user, the conditions of use (load, lubrication) of the transport chain (for example, made available by the end user), the extension of the transport chain in time (obtainable for instance from the observation that one or more links/chain segments have been removed) and the like, the components manufacturer can determine a trend of the conveyor efficiency as time passes. For example, based on the data collected from the RF tags on the conveyor components it is possible to build charts or diagrams of the trend of the efficiency of the conveyor in operation.

This allows the components manufacturer, or to the manufacturer of the transport plants, to determine in advance when the components maintenance/replacement interventions are necessary, so as to avoid that the critical components break.

Thanks also to the fact that a generic conveyor component has rather typical applications, with a relatively limited variability in terms of operating conditions, the data collected from the field and related to a certain component in certain operating conditions may also be exploited for determining the useful life of that component in different working conditions/applications. For example, once the working hours admissible for a transport chain in certain conditions of use and for a given level of efficiency have been obtained, it is possible to derive the number of kilometres that such a chain can run during its life (by multiplying the working hours for the speed of the chain, an information that can be collected from the field, as described in the foregoing), and, based on the number of kilometres, the admissible working hours for that chain in different conditions of use can be calculated, e.g. for different chain speeds or for intermittent use with longer stops (for example, a conveyor used for transporting bottles of mineral water typically has a continuous operation, while a similar conveyor for bottles of other type of drinks normally works only some hours per day).

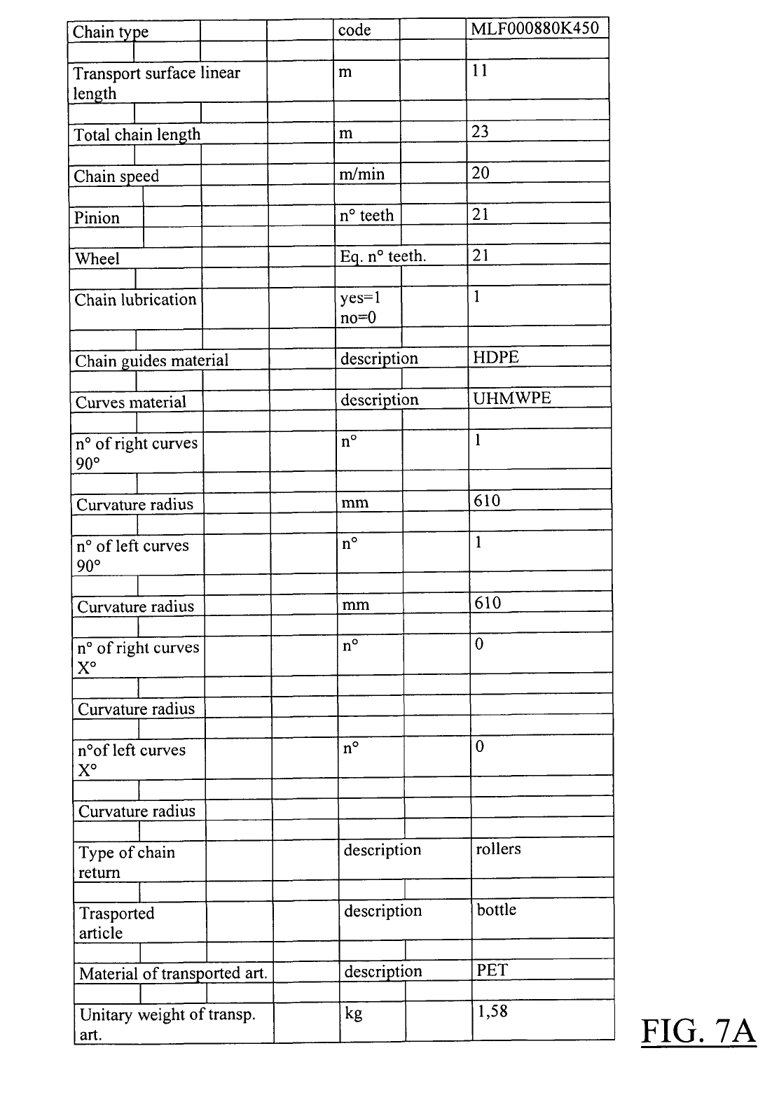

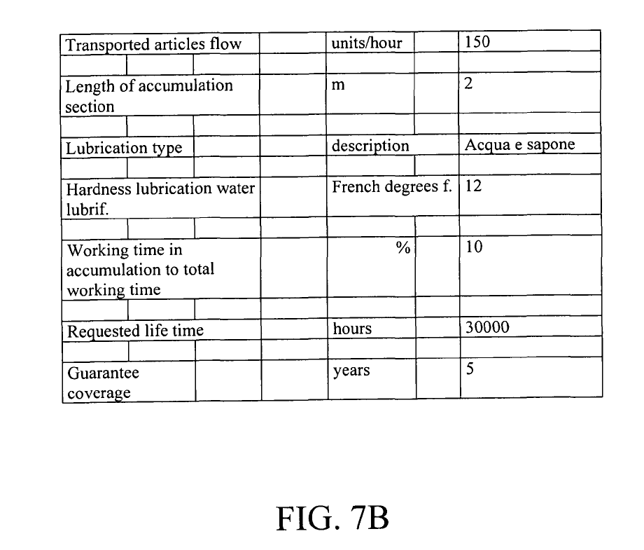

Purely by way of example, the tables in FIGS. 7A and 7B show an example of specifications that the end user may request for a certain conveyor component, for instance a transport chain.

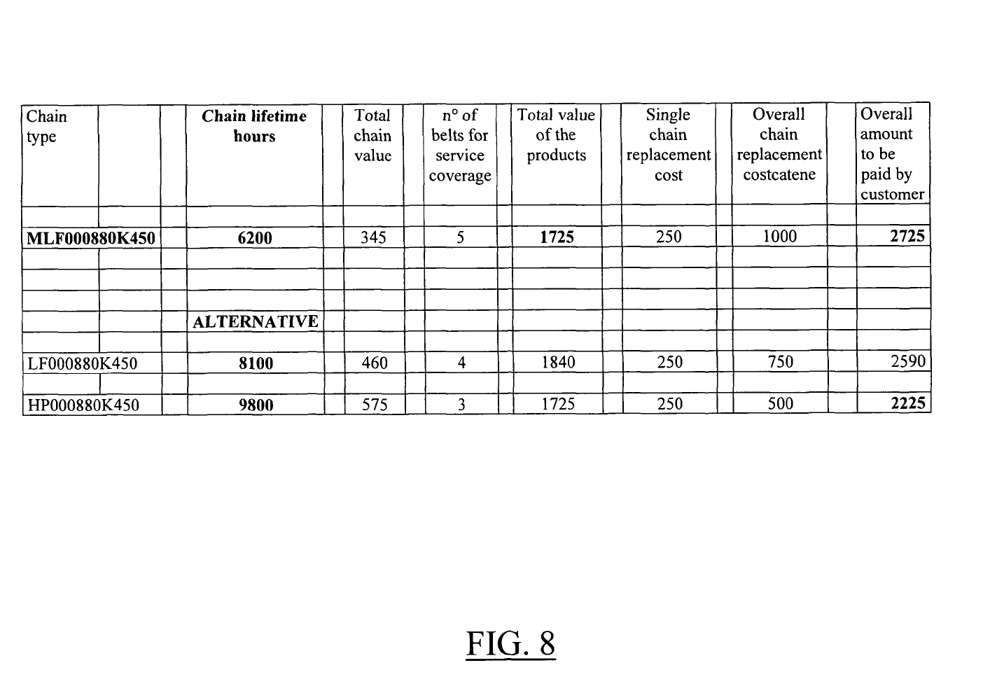

Based on these specific requests, by exploiting the statistical data collected, the plant manufacturer can identify the proposals for to the end user, reported in the table of FIG. 8.

The statistical analysis could also be conducted directly by the end user (without the necessity of sending information to the conveyors and/or conveyor components manufacturers) who could directly schedule the maintenance interventions.

Naturally, one skilled in the art may bring several changes and variations to the solution described above, with the purpose of satisfying contingent and specific needs.

For example, the concentrator 550 could be applied to a chain link, and have a wireless communication interface, for instance a WiFi interface, for communicating with the local network, or a radiofrequency communication device could be applied to a link of the generic transport chain, for communicating with the RF tags applied to the links of the chain, and capable of communicating via radio, wirelessly, with a single concentrator 550 provided for in the site of the end user.

Any suitable technology adapted to allow a radio communication can be employed for the realization of the RF tags; for example, devices in ZigBee technology could be used.

It will be appreciated that although specific embodiments of the monitoring system according to the invention are discussed separately for clarity purposes, interchangeability of compatible features discussed with reference to isolated figures is envisaged. While specific embodiments have been described above, it will be appreciated that the invention may be practiced otherwise than as described. The descriptions above are intended to be illustrative, not limiting. Thus, it will be apparent to one skilled in the art that modifications may be made to the invention as described in the foregoing without departing from the scope of the appended claims.

1. A monitoring system for a conveyor of articles comprising a plurality of conveyor components, said conveyor components being conceived to undergo a plurality of revolutions in use, the monitoring system comprising:
at least one sensor device (SM), associated with at least one conveyor component, adapted to enable determination of operating data associated with revolutions of the at least one conveyor component;
a data collection and processing system operationally coupled to the at least one sensor device, arranged to determine the operating data and efficiency data of the at least one conveyor component based on the operating data.

2. A monitoring system according to claim 1, wherein the data collection and processing system is arranged to determine a trend in the efficiency data of the conveyor.

3. A monitoring system according to claim 2, wherein the data collection and processing system is arranged to statistically analyze the operating data for determining said trend.

4. A monitoring system according to claim 3, wherein the data collection and processing system is further arranged to forecast an operating life of the conveyor components based on said trend.

5. A monitoring system according to claim 1, wherein the data collection and processing system is further arranged to signal a time for an intervention of the conveyor of articles when a level of efficiency is below a predetermined level.

6. A monitoring system according to claim 1, wherein the operating data is determined for different use conditions.

7. A monitoring system according to claim 1, wherein the operating data comprises a parameter selectable from a group consisting of: a number of revolutions, advancement speed of a conveyor component, number of stops of a conveyor component, idle state and activity state of the conveyor component and/or load data of the conveyor component.

8. A monitoring system according to claim 1, wherein said data collection and processing system comprises:
a first subsystem located locally at a user plant comprising a data collection unit coupled to the at least one sensor;
a second subsystem remote with respect to the user plant and operationally coupled to the first subsystem through a data connection.

9. The system of claim 8, in which each data collection unit comprises a local database for storing:
the operating data collected by the sensor devices of the corresponding user plant; and
identification data for identifying the conveyor component associated with the sensor device of the user plant.

10. The system of claim 9, in which the operating data is adapted to quantify the time lapsed in the activity state by the at least one conveyor component associated with the sensor device.

11. The system of claim 10, in which said time spent in the activity state is measured beginning from a first activation of the at least one conveyor component.

12. The system of claim 11, in which the identification data include, for each sensor device:
an indication of the at least one conveyor component associated with the sensor device.

13. The system of claim 11, in which the identification data include, for each sensor device, an indication of the first activation of the at least one conveyor component associated with the sensor device.

14. The system of claim 11, in which the identification data include, for each sensor device, an indication of the geometric characteristics of the at least one conveyor component associated with the sensor device.

15. The system according to claim 1, in which said sensor device is an inductive-type sensor.

16. The system of claim 1, in which said sensor device is an optical-type movement detection device.

17. The system of claim 8, comprising a plurality of sensor devices coupled to a plurality of data collection units, in which the sensor devices are coupled to the corresponding data collection unit through a wired or wireless connection.

18. The system of claim 1, in which each conveyor is provided with tags showing the identification data corresponding to the at least one conveyor component.

19. The system according to claim 18, wherein the tag comprises a barcode or an electronic transponder device.

20. A monitoring system according to claim 1, wherein:
the at least one sensor device comprises at least one radiofrequency identification element associated with the at least one conveyor component of said plurality of components, for the univocal identification of the conveyor component,
said data collection and processing system comprises
at least one radiofrequency communication device, associated with the at least one conveyor component so as to be able to communicate with the at least one radiofrequency identification element, said communicating comprising collecting the data stored in; and
a monitoring data processor coupled to the radiofrequency communication device, to receive from the communication device the data collected from the at least one radiofrequency identification element.

21. The monitoring system according to claim 20, wherein the radiofrequency identification element is further adapted to store the operational data related to said at least one conveyor component of said plurality of conveyor components; and the at least one radiofrequency communication device is arranged to write data into the at least one radiofrequency identification element associated with the at least one conveyor component of said plurality of conveyor components.

22. The monitoring system of claim 21, in which said at least one conveyor component includes at least two conveyor components, and in which the at least one radiofrequency identification element associated with one of said at least two conveyor components is adapted to store data related to the other of said at least two conveyor components, and stored on the at least one radiofrequency identification element associated with the other of said at least two conveyor components.

23. The monitoring system of claim 22, in which said at least one radiofrequency communication device is adapted, in the operation, to write on the at least one radiofrequency identification element associated with one of said at least two conveyor components the data related to the other of said at least two conveyor components.

24. The monitoring system of claim 20, in which said plurality of conveyor components includes at least one transport chain of the conveyor, said transport chain comprising a plurality of chain links.

25. The monitoring system of claim 24, in which the at least one radiofrequency identification element is made integral to the chain link.

26. The monitoring system of claim 25, in which said at least one radiofrequency identification element is embedded in the chain link.

27. The monitoring system of claim 24, in which said data related to said at least one conveyor component include registry data for the univocal identification of the link inside the transport chain.

28. The monitoring system of claim 27, in which said registry data include one or more of the followings data:
a first identification code adapted to univocally identify the transport chain including the chain link to which the identification element is associated;
a second identification code adapted to univocally identify, among the links that form the transport chain, the chain link to which the identification element is associated;
a third identification code adapted to identify the date of installation of the transport chain including the chain link to which the identification element is associated;
a fourth identification code adapted to identify the date of installation, in the chain, of the chain link to which the identification element is associated;
a fifth identification code adapted to identify a possible occurred replacement of one or more links of the transport chain including the link to which the identification element is associated.

29. The monitoring system of claim 27, wherein the operating data comprises a parameter selectable from a group consisting of: a number of revolutions, advancement speed of a conveyor component, number of stops of a conveyor component, idle state and activity state of the conveyor component and/or load data of the conveyor component, and said operating data related to said at least one conveyor component is updated through writing of data on the radiofrequency identification device by the communication device during the operation of the conveyor.

30. The monitoring system of claim 1, in which said at least one conveyor component includes a driving wheel of a transport chain of the conveyor.

31. The monitoring system of any of the preceding claims 20, in which said at least one radiofrequency communication device is placed in remote position from said at least one conveyor component.

32. The monitoring system of any of the preceding claims 20, in which said at least one radiofrequency communication device is mounted on said at least one conveyor component.

33. A method of monitoring a conveyor of articles comprising a plurality of conveyor components conceived to undergo a plurality of revolutions in use, the method comprising the steps of:
automatically determining operating data associated with revolutions of the conveyor components;
determining efficiency data of the conveyor based on the operating data.

34. A method according to claim 33, further comprising a step of determining a trend in the efficiency of the conveyor components.

35. A method according to claim 34, wherein for determining said trend the operating data is statistically analyzed.

36. A method according to claim 34, further comprising the step of forecasting an operating life of the conveyor components based on said trend.

37. A method according to any claim, 33, further comprising the step of signalling a time for an intervention of the conveyor of articles when a level of efficiency is below a predetermined level.

38. A method according to claim 33, wherein the operating data is acquired for different use conditions.

39. A method according to claim 33, wherein the operating data comprises a parameter selectable from a group consisting of: a number of revolutions of conveyor components, advancement speed of conveyor components, number of stops of the conveyor, idle state and activity state of the conveyor and/or load data of the conveyor.
